(19) United States
(12) Patent Application Publication
(10) Pub. No.: US 2025/0319848 A1
(43) Pub. Date: Oct. 16, 2025

(54) CLEANING ROBOT FOR CLEANING A LOADING SPACE OF A TRANSPORT DEVICE

(71) Applicant: KATMA ENGINEERING GMBH, Rietberg (DE)

(72) Inventors: Felix KATHOEFER, Rietberg (DE); Patrick KATHOEFER, Duesseldorf (DE)

(21) Appl. No.: 19/061,263

(22) Filed: Feb. 24, 2025

Related U.S. Application Data
(63) Continuation of application No. PCT/EP2023/074427, filed on Sep. 6, 2023.

(30) Foreign Application Priority Data
Sep. 7, 2022 (DE) 102022122695.6

(51) Int. Cl. B60S 3/00; B08B 3/02; B08B 13/00; G05D 1/648; G05D 105/10

(52) U.S. Cl. CPC B60S 3/008; B08B 3/024; B08B 13/00; G05D 1/648; B08B 2203/0217; G05D 2105/10

(57) ABSTRACT

A cleaning robot configured to clean a loading space of a transport device, the cleaning robot comprising a frame; a chassis; a cleaning unit arranged at the frame; and a sensor device, wherein the chassis includes two drive tracks drivable independently, wherein the cleaning unit includes a plurality of cleaning nozzles configured to dispense a cleaning fluid, wherein the sensor device includes at least one distance sensor configured to capture information regarding distances of the cleaning robot from side walls arranged opposite to one another and laterally defining the loading space of the transport device and to transmit the information to a data processing device, and wherein the data processing device is configured to process the information and control the chassis as a function of the information, so that the drive tracks are temporarily driven differently, so that the cleaning robot is rotatable about its vertical axis.

### RELATED APPLICATIONS

This application is a continuation of international application PCT/EP2023/074427 filed on Sep. 6, 2023 claiming priority from German patent application DE 10 2022 122 695.6 filed on Sep. 7, 2022, both of which are incorporated in their entirety by this reference.

### FIELD OF THE INVENTION

The instant application relates to a cleaning robot for cleaning a loading space of a transport device.

### BACKGROUND OF THE INVENTION

It is known in the art to use a cleaning robot for cleaning a loading space of a transport device. Reference is made to the publication document DE 10 2019 004 959 A1. The cleaning robot is moved into the loading space of the transport device in order to perform the cleaning and thereafter the cleaning robot is moveable within the loading space by an internal propulsion of the cleaning robot. The surfaces of the walls of the transport device are typically cleaned by dispensing a cleaning fluid that is sprayed through cleaning nozzles. Thus, all surfaces of the walls of the transport device are sprayed with the cleaning fluid during a movement of the cleaning robot along a longitudinal axis of the loading space so that the entire loading space is cleaned. The cleaning robot is removed from the loading space after completion of the cleaning.

US 2019/0023234A1 discloses a generic cleaning robot.

Since a loading space of a respective transport device is configured elongated it is required for completely covering the loading space that the cleaning robot runs within the loading space along an entire length of the loading space. Thus, the cleaning robot initially runs from a first end of the loading space where the doors of the loading space are typically arranged so that the loading space can be opened wherein the cleaning robot runs straight ahead in a main direction of the cleaning robot to an opposite second end of the loading space. The second end of the loading space is typically formed by a face wall of the transport device. Thereafter, the cleaning robot runs backward, this means opposite to its main direction back towards the first end of the loading space and eventually exits the loading space at the first end. In order for the cleaning robot to be centred in the loading space over an entire length of the loading space and in particular not to collide with lateral walls of the transport device, it is required to guide the cleaning robot within the loading space between the lateral walls and to correct its orientation as needed.

For this purpose it is conceivable to precisely position and orient the cleaning robot before a beginning of a cleaning process at a first end of the loading space so that a main direction along which the cleaning robot moves is oriented exactly parallel to a longitudinal axis of the loading space. This process, however, typically requires manual interaction by a person that can perform the alignment accordingly. However, an error-free alignment is not assured which typically has a negative impact on the cleaning process and can thus lead to an inferior cleaning result due to the great length of the loading area. In particular, already a few degrees deviation of the main direction from the longitudinal axis of the loading space can suffice to negatively impact the result of the cleaning process. It is also conceivable that the orientation of the cleaning robot changes while the cleaning process is automatically performed, the change occurs e.g., due to a slippage between the chassis and the floor of the loading space.

In order to guide a cleaning robot in a loading space, it is known in the art to mechanically align and guide the cleaning robot at lateral walls of the transport device using a guide device. The guide device can include lateral arms for this purpose that are in contact with the lateral walls of the transport device using guide rollers which assures a continuous centering of the cleaning robot within the loading space. This, however, is particularly disadvantageous due to the physical contact of the guide device with the lateral walls of the transport device which can cause a contamination of the lateral walls, e.g. through germ infestation which can negatively impact the cleaning result.

### BRIEF SUMMARY OF THE INVENTION

Thus, it is an object of the invention to provide a cleaning robot with improved guidance within the loading space to be cleaned.

The cleaning robot includes a frame, a chassis arranged at the frame, and a cleaning unit arranged at the frame. The frame forms a support structure of the cleaning robot wherein individual operating units of the cleaning robot, e.g. the entire chassis and the cleaning unit are attached at the frame. The frame can be formed e.g. from assembled metal profiles that are in particular bolted together and/or welded together.

The cleaning robot can be configured in particular for independent or automatic cleaning of a respective loading space. Independent or automatic according to the instant application means that cleaning to loading space is performed without user interaction. It is conceivable e.g., that a cleaning program is manually selected by a user wherein the loading space is to be cleaned according to the cleaning program. This cleaning program defines operating parameters for the cleaning robot for cleaning the loading space, e.g. a temperature of the cleaning fluid, a fluid amount to be dispensed and/or a concentration of a cleaning agent in the cleaning fluid. Thereafter the cleaning robot can clean the loading space without user interaction and thus operates independently or automatically according to the instant invention.

The cleaning robot advantageously includes a control unit, wherein the cleaning robot is controllable by the control unit to automatically clean a respective loading space. In particular, at least one operating parameter of the cleaning robot is controllable by the control unit in order to automatically perform the cleaning, e.g. a volume of cleaning fluid to be dispensed, a pressure acting to dispense the cleaning fluid or a temperature of the cleaning fluid.

The chassis is configured to enable the cleaning robot to move on a ground. The chassis can include in particular two drive tracks that are arranged at a bottom of the support frame, parallel to one another and off set from one another and in direct contact with the ground. The drive tracks can include a closed loop running band or a closed loop running chain that is supported driveable to rotate which enables the cleaning robot to move relative to the ground.

The cleaning unit is configured to dispense a cleaning fluid that is used to clean the loading space. The cleaning unit can include a plurality of cleaning nozzles configured to spray the cleaning fluid. The cleaning nozzles can be arranged and distributed at the frame of the cleaning robot and oriented in different directions in order to apply the cleaning fluid over lateral walls, a loading space floor, a loading space ceiling, and/or a face wall of the respective transport device.

The cleaning robot can be advantageously configured to clean loading spaces of trucks and tractor trailers. The transport device can therefore be in particular a truck or a tractor trailer for a truck. The loading space is typically defined by walls, in particular a loading space floor, a loading space ceiling, lateral walls and a face wall wherein the loading space floor, the loading space ceiling and the walls jointly form a cuboid space. One of the walls typically opposite to the face wall is configured openable, in particular by pivoting doors so that a load e.g. in a form of solid objects is moveable into the loading space and removeable from the loading space. The openable wall is typically closed for transporting the loading space and the respective cargo is secured in the loading space.

Cleaning the loading space can include one cleaning run or several cleaning runs. A cleaning run can include in particular a movement of the cleaning robot initially forward in a main direction of the cleaning robot along an entire length of the loading space and then back opposite to the main direction along the entire length of the loading space. Depending on a contamination of the loading space, plural cleaning processes can be required in order to achieve a desired cleanliness of the loading space.

The object is achieved according to the invention by a cleaning robot configured to clean a loading space of a transport device, the cleaning robot comprising: a frame; a chassis arranged at the frame; a cleaning unit arranged at the frame; and a sensor device, wherein the chassis is formed by a track chassis including two drive tracks drivable independently from one another, wherein the drive tracks are arranged adjacent to one another and parallel to one another in a main direction of the cleaning robot, wherein the cleaning unit includes a plurality of cleaning nozzles configured to dispense a cleaning fluid onto side walls defining a loading space of the transport device, wherein the sensor device includes at least one distance sensor configured to capture information regarding distances of the cleaning robot from the side walls arranged opposite to one another and laterally defining the loading space of the transport device at a left side viewed in the main direction of the cleaning robot and at a right side viewed in the main direction of the cleaning robot and to transmit the information to a data processing device, and wherein the data processing device is configured to process the information and control the chassis directly or indirectly as a function of the captured information, so that the drive tracks are temporarily driven differently, so that the cleaning robot is rotatable about a vertical axis of the cleaning robot, and so that the main direction of the cleaning robot is alignable relative to the loading space.

Advantageous embodiments can be derived from the dependent claims.

The cleaning unit includes a plurality of cleaning nozzles that are configured to dispense the cleaning fluid. The cleaning fluid can be sprayed under pressure through cleaning nozzles wherein the cleaning fluid is applied in particular to walls of the transport device, wherein the walls laterally define the loading area of the transport device. The cleaning unit can be configured to orient the cleaning nozzles in all directions in a plane oriented orthogonal to a longitudinal axis of the loading area, so that lateral walls as well as a loading area floor and a loading are ceiling of the transport device are loadable with the cleaning fluid during operations of cleaning with the unit. An optional activation or deactivation of individual or plural cleaning nozzles is also conceivable e.g., by using one or plural valves. This is described infra in an advantageous embodiment.

The chassis includes two drive tracks that are drivable individually and independently from each other and is thus configured as a track chassis. The drive tracks are arranged adjacent to each other and parallel to each other viewed in the main direction of the cleaning robot. Thus, the cleaning robot is moveable in the main direction by synchronously operating the two drive tracks, wherein the drive tracks are drivable in both directions so that the cleaning robot can drive forward in the main direction and can drive backward opposite to the main direction. The main direction does not change when the drive tracks are operated synchronously. Operating the drive tracks individually, particularly asynchronously, provides the ability to adjust the orientation of the cleaning robot. Thus, e.g., the two drive tracks can be driven in opposite directions or a drive track can be driven with a higher speed than the other drive track. Thus, it is also conceivable to only drive one of the drive tracks while the other drive track comes to a standstill. This operating mode causes the cleaning robot to turn about a vertical axis which causes a change of the orientation of the main direction of the cleaning robot. Thus, the chassis is operable like a tank chassis.

The sensor device includes at least one distant sensor that is provided and configured to capture information regarding a distance of the cleaning robot from a lateral wall of the transport device. Advantageously, the sensor device includes at least two distance sensors wherein one respective distance sensor is associated with a side of the cleaning robot and oriented towards the respective side. This way, the distances of the cleaning robot from both opposite side walls can be captured. The at least one distance sensor can be formed e.g., by an ultrasound sensor or a radar sensor. This way, it is possible to capture a lateral distance of the cleaning robot from a wall of the transport device at a left side viewed relative to the main direction of the cleaning robot as well as at a right side viewed relative to the main direction of the cleaning robot.

The information captured by the distance sensors is transferable to a data processing unit. The data processing unit can be configured locally at the frame of the cleaning robot or remote from the remainder of the cleaning robot. In particular, it is conceivable that the data processing unit is configured e.g. as an industrial PC arranged at the frame of the cleaning robot, e.g. within a watertight housing. It is also conceivable that the data processing device is configured as part of a control device of the cleaning robot. Alternatively, it is also conceivable that the data processing device is arranged decentralized and reachable, e.g. through a local network or through the internet, wherein the cleaning robot can additionally include a transceiver unit configured to exchange information with the data processing device.

The data processing device is provided and configured to process the information captured by the sensor device and to indirectly or directly control the chassis as a function of the captured information. Indirect control can be performed through a control unit of the cleaning robot, wherein the data processing device can be configured as part of the control unit. Controlling the chassis is performed so that the drive tracks are at least temporarily driven differently so that the cleaning robot is rotatable about its vertical axis. This provides the option to adjust the main direction of the cleaning robot in the manner described supra, wherein the cleaning robot drives in a main direction when the drive tracks are driven synchronously, wherein in particular the orientation of the main direction of the cleaning robot relative to the longitudinal axis of the respective loading space can be performed. An adjustment of the orientation of the main direction, this means a rotation of the cleaning robot about is vertical axis, can be performed in particular before the cleaning process begins in order to align the cleaning robot as precisely as possible relative to the loading space, this means the orientation of the main axis is provided as precisely parallel to a longitudinal axis of the loading space as possible. However, it is also conceivable that a correction of the orientation of the main direction is performed repeatedly during the cleaning process. Thus, it can be particularly advantageous when the information of the at least one distance sensor is processed continuously by the data processing device, so that changes of the distances from the side walls of the transport device are detected and counteracted by a rotation of the cleaning robot. Particularly advantageously, the chassis is controlled so that the cleaning robot is centered between the lateral walls of the loading space, this means the distances of the cleaning robot from the left lateral wall and from the right lateral wall are at least essentially identical.

The cleaning robot according to the invention has many advantages, in particular, it is possible to align the cleaning robot touch-free, this means without a physical contact with the lateral walls of the transport device relative to the loading space or relative to the longitudinal axis of the loading space. This solves the problem that the prior art has with aligning the cleaning robot and also solves the problem of a possible degradation of the cleaning result due to a contact of guide elements or similar with the lateral walls of the transport device. This way, a cleaning process can be performed in a particularly simple manner without having the risk of the cleaning robot colliding with the walls of the transport device. By the same token, there is a risk of unintentional contamination of the loading space through optional guide devices.

In an advantageous embodiment of the cleaning robot according to the invention, the sensor devices contain additional sensors, including distance sensors that are configured to monitor the cleaning environment of the robot. Advantageously, at least one sensor configured as a distance sensor is oriented in the main direction of the cleaning robot forward and/or at least one sensor provided in the form of a distance sensor is oriented backward against the main direction of the cleaning robot. This way, obstacles are e.g., detectable, which can have the effect that the movement of the cleaning robot is stopped waiting for a removal of the obstacle. This way, an unintentional collision of the cleaning robot with objects and thus damages to the cleaning robot can be excluded. Additionally, a distance sensor oriented in the main direction forward facilitates an automatic stopping of the cleaning robot when reaching a face wall of the transport device. This way, the cleaning robot can be operated fully automatically in a particularly simple manner, wherein the cleaning robot initially drives forward to a terminal face wall of the transport device in a first phase of the cleaning process and drives backward in a second phase of the cleaning process until the cleaning robot eventually exits the loading space at an end opposite to the terminal face wall.

Additionally, it can be particularly advantageous when at least one sensor of the sensor device is formed by a pressure sensor or by a flow sensor in order to capture information regarding a pressure or a mass flow of the cleaning fluid. Particularly advantageously, the sensor device includes a sensor formed by a pressure sensor as well as a sensor formed by a flow through sensor. These sensors facilitate e.g. detecting an error in the operation of the cleaning robot. Thus, a sensor formed by a pressure sensor can detect that a pressure that sprays the cleaning fluid by the cleaning nozzles is below a threshold pressure that is set as an operating parameter of the cleaning robot. When this pressure drop is detected, an error is presumed to be present that has to be remedied thereafter. This way, a cleaning process performed by the cleaning robot or a cleaning can be monitored particularly well. The sensor also facilitates checking effectiveness of an adjustment of at least one operating parameter of the cleaning robot. Thus, it is conceivable to temporarily increase a dispensing amount of the cleaning fluid in order to remove a local contamination of the loading space during the cleaning process so that more cleaning fluid is applied to the contamination. A pressure sensor can detect the adjustment of the flow volume that is controlled by a control device.

According to a particularly advantageous embodiment, at least one sensor of the sensor device is formed by an optical sensor, e.g., by a camera. An acoustic sensor, e.g. a radar sensor, can also be used. These sensors can monitor the loading space or the walls of the transport device that define the loading space and include the loading space floor, the loading space ceiling, and the face wall during a cleaning process. It is also conceivable to detect contamination. Obstacles or other influences that need to be considered in order to control the cleaning robot.

As a matter of principle, it is particularly advantageous for processing information that is detected by one or plural sensors that the captured information is conductible to the data processing device and processable therewith. In this embodiment, the data processing device is provided and configured to adjust or temporarily adjust at least one operating parameter of the cleaning robot as a function of the processed information indirectly or directly, for example and in particular, during a cleaning process. Thus, a dispensing amount of the cleaning fluid, a temperature of the cleaning fluid, a pressure that is used to spray the cleaning fluid, and similar, can be adjusted temporarily in order to react to conditions within the loading space that are captured by at least one sensor in the embodiment described supra. Thus, the cleaning of the loading space can be optimized overall. Additionally, a cleaning process can be performed tailored to cleaning needs, wherein a temporarily increased output of the cleaning fluid only has to be performed in the area that is contaminated when a local contamination is detected but not in the entire loading space. The operating parameter “dispensing volume of the cleaning fluid” is only adjusted temporarily in this case, advantageously. The adjustment of the at least one operating parameter is thus performed automatically as a function of the captured information so that the cleaning of the loading space can be performed self-acting or automatically.

In a particularly advantageous embodiment, at least one operating parameter of the cleaning robot that is adjustable indirectly e.g., by a control unit or directly by the data processing unit, is formed by one of the following:
Alignment of at least one cleaning nozzle;
Dispensing pressure of a cleaning fluid of at least one cleaning nozzle;
Dispensing volume of the cleaning fluid of at least one cleaning nozzle;
Activation condition of at least one cleaning nozzle;
Distance of at least one cleaning nozzle from a wall of the loading space;
Temperature of the cleaning fluid;
Movement speed of the cleaning robot;
Concentration of a cleaning agent in the cleaning fluid;
Distance of the cleaning robot from a wall of the loading space.

These operating parameters are particularly well suited to adjust a cleaning power of the cleaning robot as required. Additional operating parameters are also conceivable.

According to another advantageous embodiment of the cleaning robot according to the invention, at least one cleaning nozzle is moveable by a motor indirectly or indirectly. Further advantageously, all cleaning nozzles are moveable in this manner. Performing the direct movement, it is conceivable that the cleaning nozzle cooperates with an electrical drive that performs an adjustment and alignment of the cleaning nozzle. An indirect movement of one or plural cleaning nozzles, however, is particularly advantageous wherein e.g. a plurality of cleaning nozzles is arranged at a common nozzle rail. This nozzle rail in turn cooperates with a drive that is configured to rotate the nozzle rail about its longitudinal axis so that an orientation of cleaning nozzles associated with the nozzle rail is adjustable due to the rotation of the nozzle rail. This embodiment has the advantage that a spray direction of the cleaning fluid can be influenced. This is relevant for various phases of the cleaning process, wherein the cleaning robot moves forward in its main direction within the loading space during a first cleaning phase and the cleaning nozzles can be oriented so that they spray the cleaning fluid forward at a slant angle. During a second phase of the cleaning process where the cleaning robot moves backwards against the main direction, it is useful when the cleaning nozzles are oriented in the opposite direction at a slant angle backward so that the cleaning fluid is driven towards a first end of the transport device where the cleaning robot has entered the loading space and where the cleaning robot exits the loading space again at the end of the cleaning process. This way the cleaning fluid can be essentially removed from the loading space and then exit from the loading space at a first end of the loading space.

As described supra, it can be particularly advantageous when the cleaning unit includes a plurality of nozzle rails, wherein each nozzle rail includes a plurality of cleaning nozzles. A respective nozzle rail is advantageously rotatable about its longitudinal axis by a motor in order to adjust a dispensing direction of the cleaning nozzles into which the cleaning fluid is sprayed. Associated advantages have already been described supra.

According to another advantageous embodiment of the cleaning robot, the cleaning unit includes at least one valve, advantageously, a plurality of valves configured to adjust a flow direction of at least a portion of the cleaning nozzles that spray the cleaning fluid. Thus, it is conceivable that a portion of the cleaning nozzles is not provided with the cleaning fluid at least temporarily, during the cleaning process, and no cleaning fluid is sprayed from these cleaning nozzles. It is also conceivable that different cleaning nozzles are operated differently so that the dispensing amounts of the cleaning fluid which is sprayed by the cleaning nozzles differs. This way, the cleaning robot can be operated particularly economically, since the dispensing amount of the cleaning fluid can be adjusted locally as required.

In an advantageous embodiment, the cleaning robot includes a control unit. The control unit can include the data processing device that is configured to process the information captured by the sensors. It is also conceivable that the data processing unit is configured separate from the control unit wherein the control unit is connected with the data processing device so that data is transferrable. The control unit is provided and configured to receive information processed by the data processing unit and to control the cleaning robot as a function of this information. Advantageously, the control unit is arranged directly at a frame of the cleaning robot. Additionally, the control unit can also be provided and configured to adjust the operating parameters of the cleaning robot, e.g., as a function of a cleaning program selected by the user. These operating parameters can be set at start values or standards values in order to perform automated cleaning, wherein a deviation from these starting or standard values can be performed as a function of information captured by the at least one sensor. Thus, information is processed by the data processing unit as described supra.

Last not least, a configuration of the cleaning robot can be particularly advantageous, wherein the cleaning robot includes at least one elongated transversally oriented nozzle rail that is arranged at an upper end of the frame. Advantageously, this nozzle rail can be vertically moveable relative to the frame, maintaining an orientation of its longitudinal axis that is advantageously oriented parallel to the floor of the loading space. This configuration of the cleaning robot facilitates a particularly simple cleaning of the end face wall of the transport device at the second end of the loading space that is arranged opposite to the end where the cleaning robot enters the loading space. Thus, the cleaning unit can spray the lateral walls and the loading space floor of the transport device with the cleaning unit during the movement of the cleaning robot in the direction towards the second end while driving forward in the main direction. As soon as the robot has reached the face wall of the transport device the forward movement is stopped so that the cleaning robot stops. The stop can be performed based on a processing of information of a forward oriented distance sensor. In this position, the cleaning robot can be at a distance between 10 cm and 60 cm from the face wall and can spray the face wall with the cleaning fluid by the transversally oriented nozzle rail. Thus, the nozzle rail including the cleaning nozzles arranged thereon is moved vertically downward from the upper end of the frame, wherein the cleaning nozzles are advantageously oriented so that they are configured to spray the face wall with the cleaning fluid. Advantageously, the nozzle rail is moved to a lower end of the frame before the movement is inverted and the nozzle rail is moved back to the original upper end of the frame. Now, the nozzle rail can be rotated about its longitudinal axis and the orientation of the cleaning nozzles can be adjusted again so that the nozzle rail is configured for spraying the loading space ceiling again in the second phase of the cleaning process in which the cleaning robot moves backward against the main direction in a direction towards the first end of the loading space. Thus, this cleaning robot facilitates loading and cleaning all walls of the transport device with the cleaning fluid in a simple manner.

### BRIEF DESCRIPTION OF THE DRAWINGS

The invention is subsequently described based on an advantageous embodiment with reference to drawing figures, wherein:

FIG. 1 illustrates a vertical longitudinal sectional view of a set including a cleaning station and a transport device;

FIG. 2 illustrates a horizontal sectional view of the set according to FIG. 1;

FIG. 3 illustrates a perspective view of a cleaning station;

FIG. 4 illustrates a front view of the cleaning station according to FIG. 3;

FIG. 5 illustrates a vertical longitudinal sectional view of the cleaning station according to FIG. 3;

FIG. 6 illustrates a perspective view of a cleaning robot;

FIG. 7 illustrates a front view of the cleaning robot according to FIG. 6; and

FIG. 8 illustrates a side view of the cleaning robot according to FIG. 6.

### DETAILED DESCRIPTION OF THE INVENTION

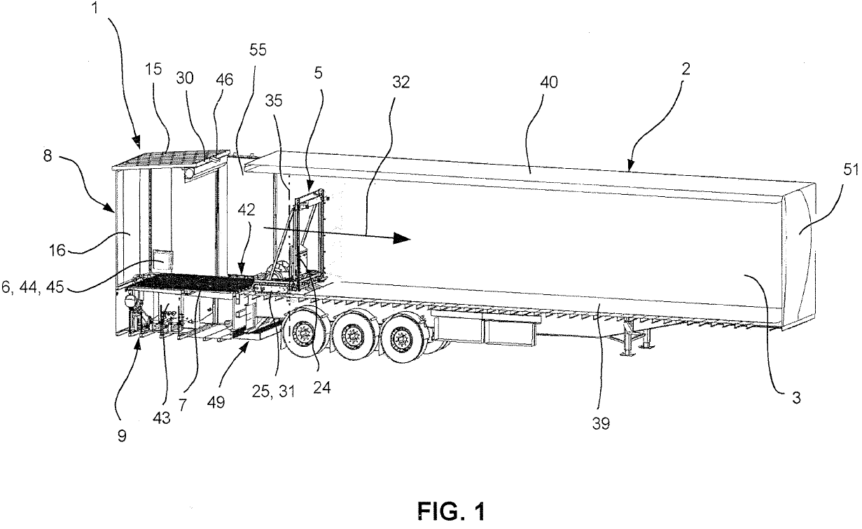

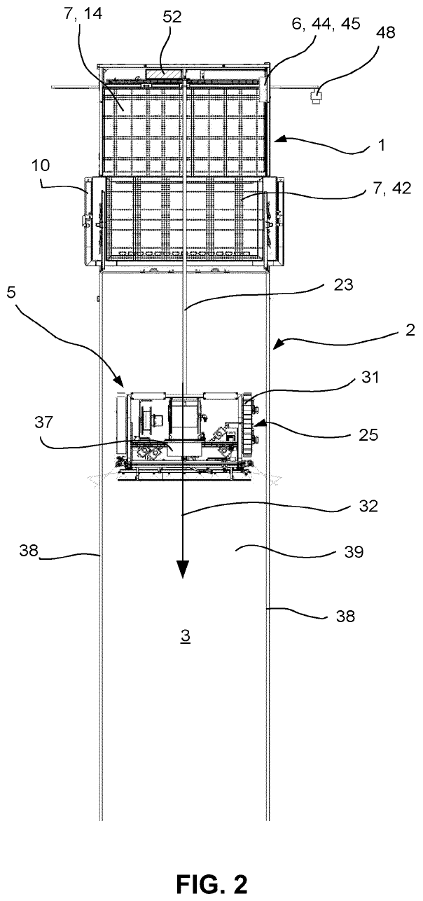

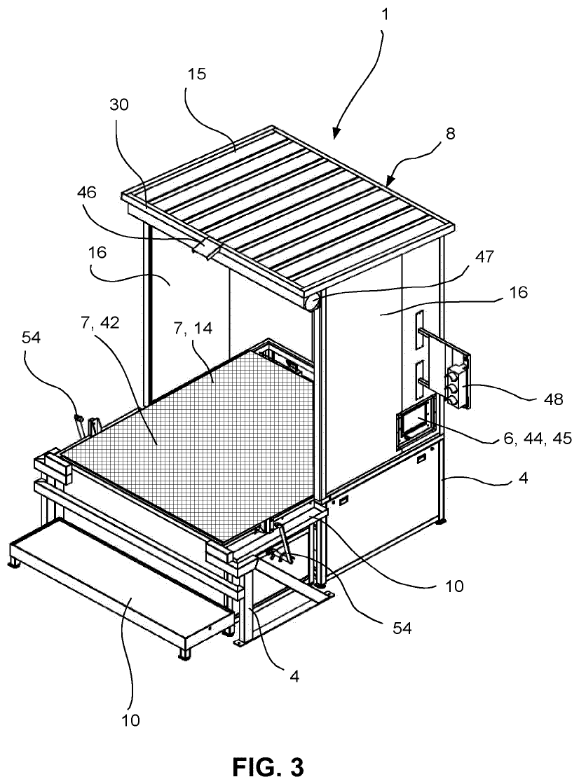

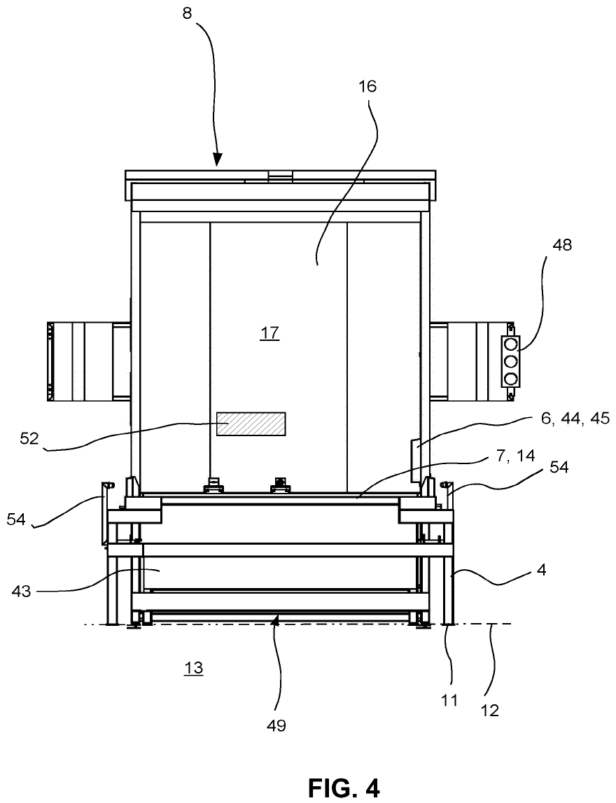

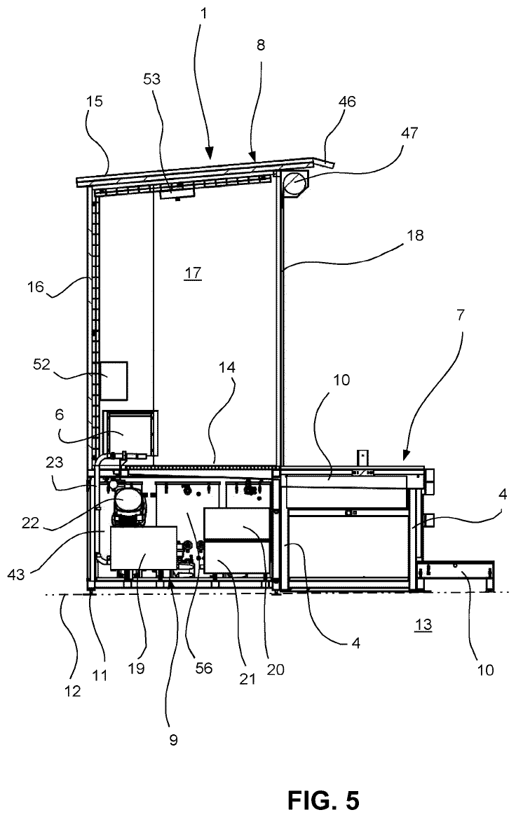

An embodiment illustrated in FIGS. 1-8 includes a cleaning station 1 including a cleaning robot 5 for cleaning a loading space 3 of a transport device 2. The transport device 2 is formed in this embodiment by a trailer with a loading space 3 that is to be cleaned. In order to perform the cleaning, the transport device 2 is positioned relative to the cleaning station 1 so that the cleaning robot 5 can enter the loading space 3 of the transport device 2. The cleaning robot 5 is provided and configured to perform the cleaning of the loading space 3 self-acting or automatically, this means, in particular, without interaction from a user of the cleaning station 1.

The cleaning station 1 that is illustrated in FIGS. 1-5 includes a support frame 4 that forms a pedestal 7 at an end oriented away from a ground 13. The pedestal 7 is thus offset from the ground 13, wherein the pedestal 7 forms a flat driving plane that is oriented essentially parallel to a surface of the ground 13. The arrangement of the pedestal 7 as described supra enables the cleaning robot 5 that is supported on the pedestal 7 to enter the loading space 3 of the transport device 2 from the pedestal 7 without having to cover an elevation difference, wherein the pedestal 7 and a loading space floor of the transport device 2 are at least on a similar, advantageously on the same elevation level.

The cleaning station 1 furthermore includes a garage 8 in which the cleaning robot 5 is storable in a parking position when not in use. The garage 8 includes a plurality of side walls 16, a floor 14, a ceiling 15, wherein these elements jointly enclose an interior space 17 of the garage 8. The interior space 17 is defined by a side wall 16 towards a front side of the garage 8, wherein the side wall 16 is formed by an openable space divider 18. The space divider 18 is optionally moveable between an open position and a closed position. In the illustrated embodiment, the space divider element 18 is formed by a rolling door which is rolled up and stored in a storage box 47 when the space divider element 18 is provided in its open position. When the space divider 18 is in its closed position, it secures the interior of the garage 8 against unauthorized access. The floor 14 of the garage 8 is formed by the pedestal 7 in the illustrated embodiment so that the floor 14 of the garage 8 extends from an outer area 42 of the pedestal 7 without any elevation difference. Thus, the cleaning robot 5 can move out of the garage 8 without having to drive up or down a step or a ramp or similar.

The support frame 4 of the cleaning station 1 includes a plurality of stand elements 11 which support the cleaning station on the ground 13 in a support plane 12. As stated supra, the pedestal 7 is oriented parallel to the support plane 12. Since there is a distance between the support plane 12 and the pedestal 7, an intermediary space 43 is provided between the pedestal 7 and the support plane 12 wherein a fluid supply 9 is arranged in the intermediary space 43. The fluid supply includes a plurality of fluid tanks 19, 20, 21, and a pump 22. A first fluid tank 19 is formed by a water tank and is configured to store fresh water in the illustrated embodiment. The first fluid tank 19 can be configured with a supply connection in the illustrated embodiment, wherein the fluid tank 19 is connectible to an external supply conduit so that it is fillable with fresh water, e.g. from a municipal water supply. The fluid supply 19 also includes a second fluid tank 20 which is formed by a cleaning fluid tank. Thus, the second fluid tank 20 is configured to store a cleaning fluid that is provided for dispensing into the loading space 3 by the cleaning robot 5. The third fluid tank 21 is configured as a cleaning fluid tank to store the cleaning fluid which is typically formed by a particular chemical mixture. The cleaning fluid that is stored in the second fluid tank 20 is typically formed by a mixture which includes captured cleaning fluid which was previously applied by the cleaning robot 5 and then captured again by the capture device 49 and fresh cleaning fluid. The cleaning robot 5 is supplied with the cleaning fluid from the second fluid tank 20 which is flow-connected with the cleaning robot 5 by a fluid conduit 23. The pump 22 cooperates with the fluid conduit 23 so that it is configured to pump the cleaning fluid stored in the fluid tank 20 through the fluid conduit 23 into the cleaning robot 5 that eventually sprays the cleaning fluid.

The cleaning station 1 further includes a capture device 9 which includes plural capture containers 10 in the illustrated embodiment wherein the capture containers are configured to capture and re-circulate cleaning fluid dispensed during the cleaning of the transport device 2. Individual capture containers 10 are respectively arranged at a level below an upper driving plane of the pedestal 7 for this purpose. Additionally, the driving plane of the pedestal 7 where the cleaning robot 5 can drive is formed by a grate so that dispensed cleaning fluid 10 can drain downward through the grate and can be supplied to the capture device 49 in this way.

The cleaning station 1 can additionally include a processing device 56 wherein captured cleaning fluid is feedable to the capture device, in particular, by a pump. The processing device 56 facilitates processing the cleaning fluid so that the cleaning fluid is at least partially suitable for performing another cleaning process. Processing the cleaning fluid can be performed, in particular, by filtering solids out of the cleaning fluid using one or plural filters. The portion of the processed cleaning fluid that is suitable for further use is then fed into the second fluid tank 20. As stated supra, additional cleaning fluids can be fed into the fluid tank 20.

The cleaning station 1 additionally includes an energy supply configured to supply the cleaning station 1 and, in particular, the cleaning robot 5 with electrical energy. This supply can be performed indirectly or directly wherein in particular a certain amount of electrical energy can be stored in an intermediary battery. The energy supply includes a supply connection that is connectible with an external supply conduit.

Additionally, the cleaning station 1 includes a control unit 6 that is fixed at a sidewall of the garage 8. The control unit 6 is configured and provided to control the cleaning station 1 and, in particular, the cleaning robot 5. For this purpose, the control unit 6 is connected in a data transferring manner with the cleaning robot 5 by at least one data connection. This data connection can be hardwired or provided wirelessly. In the illustrated embodiment, the cleaning robot 5 is connected to the cleaning station 1 with an additional supply conduit in addition to the fluid conduit 23, wherein the cleaning robot 5 is suppliable with electric energy from the energy supply and also with data from the control unit 6.

In the illustrated embodiment, the control unit 6 includes a data processing device which is configured to electronically process supplied information. This can be in particular information that is captured by various sensors which will be described infra. Processing this information is used in the illustrated embodiment to control the cleaning robot 5 by the control unit 6 as required and to influence a cleaning process of the storage space 3 of the transport device 2 in this manner.

The control unit 6 includes an input device 44 and a display device 45 in the illustrated embodiment which are combined in a touch screen display. This way, the operator of the cleaning station 1 is enabled to perform inputs relating to at least one cleaning process or the entire cleaning job. It is conceivable, for example, to display options for various cleaning programs to the user through the display 35 wherein the user can select between the cleaning programs. Depending on which of the cleaning programs is selected, at least one cleaning process of the storage space 3 is controlled for the cleaning robot 5 by the control unit 6. Different cleaning programs can cause different operating parameters of the cleaning robot 5 so that the cleaning can be performed in different ways automatically as a function of the selected cleaning program.

The cleaning station 1 additionally includes a signalling device 48 which can be laterally connected to a side wall 16 of the garage 8 like a traffic light. The signalling device 48 can be used for different purposes. In particular, the signalling device 48 can optically indicate to the driver of a respective transport device 2 that a parking position relative to the cleaning station 1 has been reached. It is understood that the transport device 2 has to be positioned relative to the cleaning station 1 so that the cleaning robot 5 can drive from the pedestal 7 into the loading space 3 of the transport device 2. It is particularly advantageous when only a small or no elevation difference is provided between an elevation level of a loading space floor 39 of the loading space 3 to be cleaned and an elevation level of the driving plane of the pedestal 7.

In order to secure the support frame 4 against unintentional impact of a transport device 2 driving into its parking position, it can furthermore be advantageous when the cleaning station 1 includes a crash bumper. The crash bumper is arranged relative to the transport frame 4 so that the transport device 4 initially contacts the crash bumper when driving towards the cleaning station 1 before impacting the support frame 4. The crash bumper can be anchored in the ground e.g. by a foundation. In order to be able to flexibly deploy the cleaning station without ground construction, it is particularly advantageous when the crash bumper is stabilized by the weight of the transport device 2. For this purpose, the crash bumper can include a ram, which is connected at one end at an elongated base plate. The elongated base plate can be oriented relative to the transport frame 4 so that the transport device 2 drives onto the base plate when moving into a parking position at the cleaning station 1 and thus fixes the crash bumper relative to the ground 13 by friction locking.

Furthermore, the signalling device in the illustrated embodiment is configured to optically display an elevation difference between the elevation level of the loading space floor of the transport device 2 and the elevation level of the driving plane of the pedestal 7 to the driver of the transport device 2. For the reasons recited supra, this elevation difference shall be minimal, advantageously zero so that the cleaning robot does not have to cover any elevation difference when moving from the pedestal 7 into the loading space 3. An adaptation of the elevation level of the loading space floor 39 to the elevation level of the pedestal 7 can be performed in particular by the transport device 7, so that the driver can perform the adaptation in view of the signal displayed by the signalling device.

Additionally, the cleaning station 1 includes two door supports 54, wherein one respective door support is arranged at one respective side of the pedestal 7. The door supports 54 are used to stop the doors 55 of the transport device 2 in their open position. This is evident, in particular, from FIG. 1. Due to the extension of the pedestal 7 in its outer area 42, it is possible to position doors 55 of the transport device 2 in their open position respectively, lateral from the pedestal 7 and to make the loading space accessible for cleaning by the cleaning robot 5 in this way. Thus, the cleaning robot 5 is positioned outside the garage 8 in the outer portion 42 of the pedestal 7 and activated so that the doors 55 arranged laterally from the pedestal 7 are loaded with the cleaning fluid and thus cleaned. The door supports 54 are used to stop the doors 55 during the cleaning so that the cleaning can be performed reliably. In particular, the door supports 54 can respectively include a suction cup that is configured to grip a respective door 55 at an outside through vacuum. The door supports 54 can be arranged at the support frame 4 in a force transferring manner and can react forces into the door frame 4, wherein the forces are generated by stopping the doors 55. Advantageously, the door supports 54 are arranged so that they are suitable for stopping the doors 55 at an opening angle of approximately 90 degrees.

The cleaning station 1 additionally includes a sensor 46 that is formed by a camera in the illustrated embodiment. The sensor 46 is arranged at a front wall 30 of the roof 15 of the garage 8. The sensor 46 is oriented forward in a direction towards a front end of the cleaning station 1 or towards the transport device 2 so that the sensor is configured to capture optical information relating to the transport device 2 and the loading space 3. The sensor 46 is connected with the data processing device so that data is transferable wherein the data processing device is configured as part of the control device 6 according to the embodiment described supra. This way, it is possible to transfer information captured by the sensor 46 to the data processing device and process the data in the data processing device.

The sensor 46 is configured in particular to capture at least one identifying feature of the transport device 2. In the illustrated embodiment the sensor 46 is configured to optically capture a license plate of the transport device 2, wherein the license plate functions as an identifying feature of the transport device 2. Information captured this way is compared to data already provided in the data processing device relating to the transport device 2 and stored in a database. This database is not configured in the illustrated embodiment locally as part of the data processing device, but is arranged in a cloud, wherein an exchange of data between the database and the data processing device is performed through the internet. Data is stored in the database facilitating an association of the optically captured license plate through the sensor 46 with the transport device 2 so that the transport device 2 is clearly identified whose loading space 3 is to be cleaned.

The identification of the transport device 2 thus performed is furthermore used to generate a cleaning certificate after the cleaning of the loading space 3 is completed, wherein the cleaning certificate documents the completed cleaning. This cleaning certificate is then associated with the identified transport device 2 and documented in a database. This can be e.g. the same database that includes the association of the license plate with the transport device 2. This type of data processing provides in particular the option to access the cleaning certificate any time by accessing a user account of a respective customer regarding the transport device 2 that is part of a fleet of that customer and to report the successful performance of the cleaning of the loading space 2 as may be required by a controlling authority.

Additionally, the identification of the respective transport device 2 can be useful in order to control the cleaning robot 5 for at least one cleaning process that is to be performed. It is conceivable that the type of the transport device 2 is stored in the database with respect to the transport device 2 and which type of contamination of the loading space 3 is to be expected. The transport device 2 may have been used to transport food products which constitutes certain requirements for cleaning the loading space 3. Thus, the identification of the transport device 2 facilitates automatically setting at least one operating parameter of the cleaning robot 5 for at least one cleaning process so that the cleaning process can be adapted to the expected contamination and a pre-determined cleaning goal. It is conceivable that the cleaning fluid dispensed by the cleaning robot 5 is heated to a pre-determined temperature for cleaning the loading space 3 where food products were transported previously in order to efficiently remove the contamination of the loading space 3. It is also conceivable that the cleaning is performed in view of the next cargo that is to be transported. Furthermore, the sensor 46 is provided and configured in the illustrated embodiment to optically capture an elevation difference between the elevation of the loading space floor and the elevation of the driving plane of the pedestal 7 and to conduct the corresponding information to the data processing device. The data processing device is configured to process the information and to provide information to the driver of the transport device 2, e.g. by the signalling device 48 in order to give feedback to the driver regarding the anticipated elevation difference. The driver is subsequently enabled to perform an elevation adjustment of the transport device 2, e.g. by a pneumatic system of the transport device 2. The adaptation is advantageously performed so that no elevation difference exists anymore between the loading space floor 39 and the pedestal 7.

Last not least the sensor 46 is provided and configured in the illustrated embodiment to optically detect the loading space 3 or the walls 38, the loading space floor 39 and/or a loading space ceiling 40 of the transport device 2. Information captured in this manner is transmitted to the data processing device and processed therewith which enables detecting objects in general and in particular obstacles and/or contamination. The contamination can be provided in particular as contamination at the surfaces of the walls 38, the loading space floor 39 and/or the loading space ceiling 40. The data processing device is provided and configured to process the captured information and to control the cleaning robot 5 as a function of the information or as a function of the processing of the information.

The control includes in particular that at least one operating parameter of the cleaning robot 5 is set for at least one cleaning process of the respective loading space 3. It is also conceivable to locally capture a contamination at a wall 38 of the transport device 2 by the sensor 46 and to control the cleaning robot 5 as a consequence of the processing of the information captured in this manner so that the cleaning robot temporarily reduces its driving speed in the longitudinal direction of the loading space in an area of the detected contamination. This increases an application of the cleaning fluid to the location of the local contamination so that the contamination is removed in a controlled manner. It is also conceivable that a dispensing amount of the cleaning fluid that is dispensed locally in the area of the contamination by the cleaning robot 5 or a cleaning nozzle 33 is increased temporarily in order to load the contamination with an increased amount of cleaning fluid. This way, the cleaning robot 5 can be controlled as required for a respective cleaning process through the cooperation of the sensor 46 with the data processing unit of the control unit 6. An adjustment of at least one operating parameter of the cleaning robot 5 while performing the cleaning process and/or between different cleaning processes is also possible.

In the illustrated embodiment, as sensor may be formed by a Lidar. This sensor is used to capture dimensions of the loading space 3. The information thus captured can be used to control the cleaning robot 5 to perform the cleaning automatically and/or to adjust at least one operating parameter for at least one cleaning process.

It is also possible to capture a contaminations condition of the loading space 3 by a sensor that is formed by a camera or a lidar after completing the respective cleaning process. It is conceivable for example, that remaining solid objects or fluid puddles are detected in the loading space 3 by the lidar sensor. In case no contamination is detected, the cleaning is deemed sufficient and terminated. An automatically generated cleaning certificate can be the result of the post-inspection of the loading space 3 wherein the cleaning certificate not only documents that a prescribed cleaning was performed but also documents that an intended cleaning result has been achieved. Thus, it is conceivable that requirements for a cleaning success relating to an identified transport device are stored. Checking these requirements can be performed by sensor detection through at least one sensor, wherein the generated cleaning certificate documents the cleaning success when these requirements are met.

In case a propulsion of the cleaning robot 5 is impaired so that the cleaning robot 5 cannot exit the loading space of the respective transporter under its own power, it is required to still remove the cleaning robot 5 from the loading space 3 so that the transport device 2 is clean and can leave the cleaning station 1. This failure can be caused by a chassis 25 of the cleaning robot 5 being damaged or the power supply having failed or similar. In order to reliably remove the cleaning robot 5 from the loading space 13, the cleaning station 1 includes a winch 52 in the illustrated embodiment wherein the winch 52 is arranged at a rear side wall 16 of the garage 8. The winch 52 includes a storage roller where a pull cable is would up. This pull cable can be connected with the cleaning robot 5 in a force transferring manner so that the pull cable is wound onto the storage roller by a rotation drive of the storage roller so that the cleaning robot 5 is extracted backward from the loading space 3 against the main direction 32 of the cleaning robot 5. The cable winch 52 can be operated manually by a crank or by an electric drive. The cable winch 52 can be supplied with electrical energy from a battery in order to remain functional when an external power supply fails.

Additionally, the cleaning station 1 includes a cleaning device 53 in the illustrated embodiment, wherein the cleaning device is arranged at a bottom side of the roof 15 of the garage 8. The cleaning device 53 is configured to load the cleaning robot 5 with the cleaning fluid and thus clean the cleaning robot 5 when it is in its parking position in which the cleaning robot 5 is parked in the interior 17 of the garage 8. Thus, the cleaning device 53 can include in particular at least one cleaning nozzle that is configured to spray the cleaning fluid from above onto the cleaning robot 5. After the application of the cleaning fluid has been completed, a flushing with fresh water can be performed by the cleaning device 53. Advantageously, the space divider element 18 is closed when the cleaning of the cleaning robot 5 is performed within the garage 8.

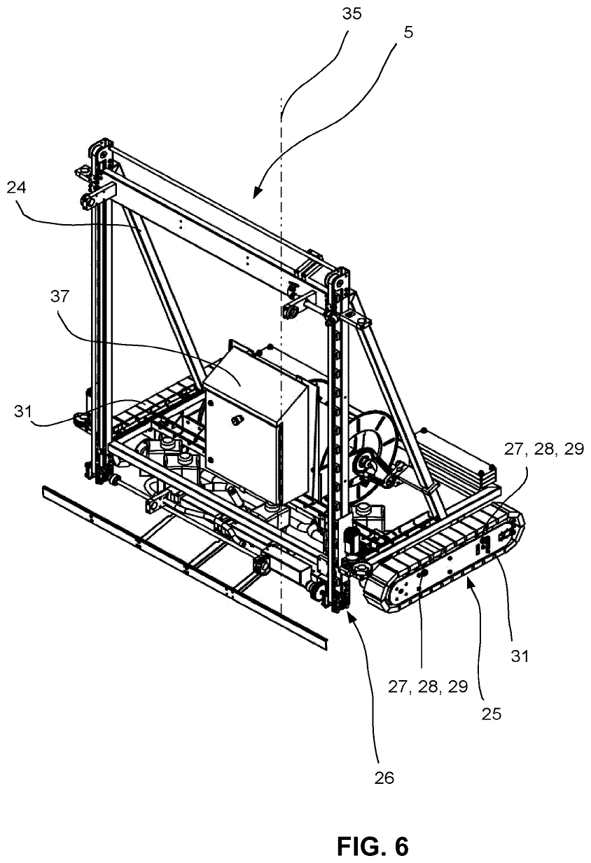

As recited supra, the cleaning of the respective loading space 3 is performed by the cleaning robot 5 automatically or self-acting. This is evident in particular from FIGS. 6-8. The cleaning robot 5 includes a frame 24 which forms a support frame of the cleaning robot 5. Additionally, the cleaning robot 5 includes a chassis 25 which includes two drive tracks 31 in the illustrated embodiment, wherein the two drive tracks are arranged adjacent and parallel to one another. The drive tracks 31 in turn respectively include a running band or a running chain that is internally closed and drivable to revolve so that the cleaning robot 5 is movable relative to a ground using the drive tracks 31. Thus, the drive tracks 31 are arranged at a bottom side of the frame 24 that is oriented towards the loading space floor 38 and drivable independently so that the cleaning robot 5 can be moved and controlled like a tank. In particular, a main direction 32 in which the cleaning robot 5 moves forward when synchronously driving the drive tracks 31 can be adjusted by asynchronously driving the drive tracks 31 so that the cleaning robot 5 rotates about its vertical axis 35.

The cleaning robot 5 additionally includes a cleaning unit 26 that is configured to dispense the cleaning fluid onto the walls 38, the loading space floor 39, the loading space ceiling 40, and the doors 55 of the transport device 2. Thus, the cleaning unit 26 includes a plurality of cleaning nozzles 33 that are arranged and distributed at the frame 24. The cleaning nozzles 33 are arranged at a front end of the cleaning robot 5 and respectively oriented to the sides or upward and downward in order to apply the cleaning fluid to the associated surfaces of the loading space 3. In order to adjust the orientation of the cleaning nozzles 33 during a cleaning process, a plurality of the cleaning nozzles 33 is arranged at elongated nozzle rails 36 in the illustrated embodiment wherein the nozzle rails 36 are respectively pivotably supported about a longitudinal axis 34. In the illustrated embodiment, each direction is associated with a nozzle rail 36. This way, it is possible to operate the cleaning nozzles 33 in a first orientation relative to the walls 38, the loading space floor 39, and the loading space ceiling 40 when the cleaning robot 5 moves forward in the main direction 32. After reaching a face wall 51 of the transport device 2, the drive direction of the drive tracks 31 is reversed so that the cleaning robot 5 moves backward opposite to the main direction 32 back towards the pedestal 7. Before the reverse movement starts, the nozzle rails 36 are pivoted about their respective longitudinal axis 34 in order to remove dislodged contaminations from the loading space 3 so that the cleaning nozzles 33 are oriented backward. This way, continued operation of the cleaning nozzles 33, this means spraying the cleaning fluid, flushes the contaminations in the direction of the pedestal 7 and out of the loading space 3.

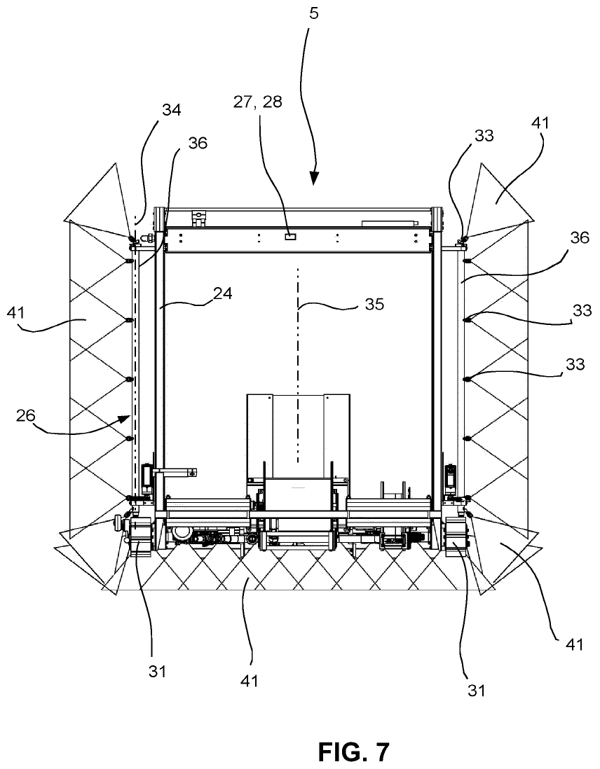

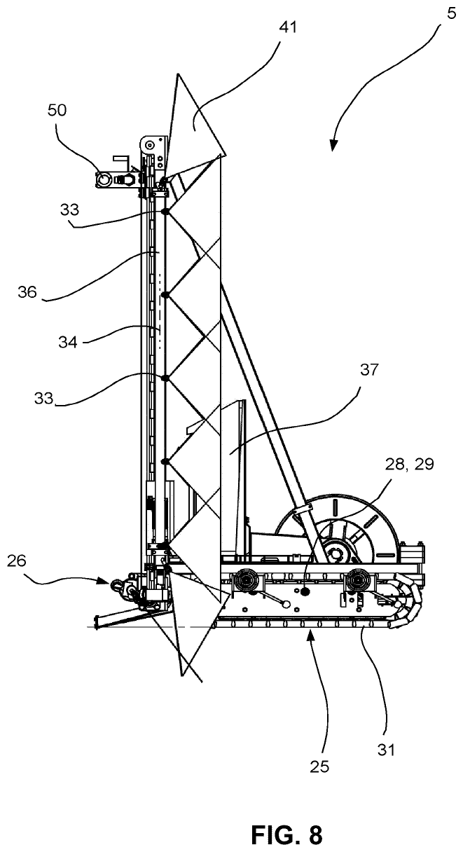

Dispensing the cleaning fluid through the cleaning nozzles in spray cones 41 is shown in FIGS. 7 and 8. Adjusting the cleaning nozzles 36 is shown in the illustrated embodiment motor driven, wherein an electric drive is associated with each nozzle rail 36. The adjustability of the nozzle rails 36 and thus of the dispensing direction of the cleaning nozzles 33 is advantageous for targeted removal of local contaminations or dirt spots. Advantageously, these dirt spots can be sprayed with the cleaning fluid from different directions so that the dirt spots are scraped from the respective surface like using a high-pressure cleaner. Adjusting the dispensing direction of the cleaning fluid helps to achieve a particularly high cleaning performance.

Additionally, the cleaning unit 26 includes a plurality of valves configured to adjust the supply of the cleaning fluid to the individual nozzle rails. The valves can be used for throttling a flow-through amount of the cleaning fluid and also for cutting off plural nozzle rails completely. This way, it is possible to apply the cleaning fluid in a controlled manner to particular locations of the loading space 3, e.g. to a strong contamination on a surface of a wall 38 of the transport device 2 which is not present in the same severity at the other walls 38.

Furthermore, it is particularly advantageous when the upper, transversally-extending nozzle rail 50 that is shown in FIG. 8 is moved downward along the frame 24 after reaching the face wall 51 of the transport device 2 and reversing the driving direction of the cleaning robot 5. This way, it is possible to apply the cleaning fluid to the face wall 51 through the cleaning nozzles 33 that are arranged at the nozzle rail 50 so that the face wall 51 is cleaned, as well. Accordingly, the cleaning robot 5 is configured so that the nozzle rail 50 is vertically moveable along the frame 24, e.g., by a threaded rod that is drivable to rotate. Before the cleaning robot 5 starts driving backwards, the nozzle rail 36 is moved up again so that it can clean the loading space ceiling 40 during the backward movement. In order to change the orientation of the cleaning nozzles 33 that are arranged at the transversally-extending nozzle rail 50, the nozzle rail 50 cooperates with the electrical drive as described supra that pivots the nozzle rail 50 about its longitudinal axis 34. Thus, the cleaning nozzles 33 can be oriented towards the face wall 51 at least during the downward movement of the nozzle rail 50.

The cleaning robot 5 in the illustrated embodiment furthermore includes an electrical cabinet 37 which may include, in particular, a control unit 6. This is particularly advantageous in an embodiment where the control unit 6 that is arranged in the illustrated embodiment at the support frame 4 or at the garage 8 is locally arranged at the cleaning robot 5. Additionally, the electrical cabinet 37 can include additional switching devices for locally controlling the cleaning robot 5.

The cleaning robot 5 additionally includes a sensor device 27 including a plurality of sensors 28. The plurality of the sensors 28 is formed, in particular, by distance sensors 29, wherein two respective distance sensors 29 are arranged at the drive tracks 31 in the illustrated embodiment. This is evident, in particular, from FIG. 6. The distance sensors 29 can also be arranged laterally at the frame 24. The distance sensors 29 are used to detect a lateral distance of the cleaning robot 5 from the lateral walls 38 of the transport device 2, this means from the left side and also from the right side of the cleaning robot 5. The distance sensors 29 are thus formed by ultrasound sensors. Determining the distances of the cleaning robot 5 from both sides with reference to the side walls 38 of the transport device 2 facilitates determining the orientation of the cleaning robot 5 or the main direction 32 of the cleaning robot 5 with reference to a longitudinal axis of the loading space 3. Thus, information captured by the distance sensors 29 is conducted to the data processing device and processed by the data processing device. It has to be prevented during a cleaning process of the loading space 3 that the cleaning robot 5 contacts the walls 38 of the transport device 2 while driving, in particular a collision has to be prevented. Therefore, the orientation of the main direction 32 relative to the longitudinal axis of the loading space 3 is very important.

The information captured by the distance sensors 29 is used to determine the orientation of the cleaning robot 5 within the loading space 3 and correct the orientation as needed. In order to perform this correction, a rotation of the cleaning robot 5 about its vertical axis is required. Also in order to perform this rotation, information captured by the distance sensors 29 as recited supra is processed by the data processing device and the chassis 25 is controlled by the data processing device, in this case directly by the control unit 6, so that the drive tracks 31 of the chassis 25 of the cleaning robot 5 are operated asynchronously. It is also conceivable that only one of the drive tracks 31 is driven while the other drive track 31 is at a standstill. It is also possible that the drive tracks 31 are temporarily driven in opposite directions or with different speeds in the same direction. This concept and other concepts cause the intended rotation of the cleaning robot 5 about the vertical axis 35 and thus an adjustment of the main direction 32 in which the cleaning robot 5 travels when the drive tracks 31 are driven synchronously. This way, the cleaning robot 5 can be oriented in a particularly simple manner within the loading space 3 so that the cleaning robot travels parallel to the longitudinal axis of the loading space 3 during the cleaning process. Distances of the cleaning robot 5 from the lateral walls 38 can be checked continuously wherein a correction of the main direction 32 can be performed repeatedly as described supra. Thus, the orientation of the cleaning robot 5 can be performed within the loading space 3 without having to establish physical contact to the lateral walls 38. Additionally, it is possible in a particularly simple manner to position the cleaning robot 5 at least essentially centrally between the lateral walls 38 of the transport device 2, so that the lateral distances of the cleaning robot 5 from the walls 38 are kept at least essentially equal.

Furthermore, the sensor device 27 includes additional sensors 28 that are formed by distance sensors 29. In particular, a distance sensor 29 is arranged at a front side of the cleaning robot 5 and oriented in the main direction 32 so that a distance of the cleaning robot 5 from an obstacle arranged in the main direction of the cleaning robot 5 is detectable. This way, the cleaning robot 5 can be positioned in a particularly simple manner relative to the front face wall 51 of the transport device 2, so that the cleaning robot 5 can be stopped in a timely manner before colliding with the front face wall 51. Additionally, the sensor device 27 includes a distance sensor 29 oriented in a rear direction of the cleaning robot 5. This sensor can be particularly advantageous for moving into the parking position within the garage 8, wherein a distance of the cleaning robot 5 from the rear wall 16 of the garage can be detected.

The sensor device 27 includes an additional sensor 28 in this embodiment that is formed by a combined temperature and humidity sensor. This sensor 28 facilitates capturing information regarding temperature and humidity in the loading space 3 during a cleaning process. This information is processed, in particular, by the data processing device of the control unit 6, so that an operating parameter of the cleaning robot 5 can be adjusted as a function of the detected information. The captured information can also be used to monitor the cleaning and to assure and document the quality of the cleaning. Respective data can be documented as part of the cleaning certificate recited supra.

Additional sensors can be formed, e.g. by a pressure sensor or a flow-through sensor that are configured to capture information relating to the cleaning fluid. Thus, it can be determined which flow-through amount of cleaning fluid is dispensed at a nozzle rail 36 or what pressure is applied to dispense the cleaning fluid through the cleaning nozzles 33. This information can be used to adjust the control of the cleaning robot 5 and to influence the operating parameters accordingly. Disturbances in the fluid supply 9 are also detectable wherein a sudden drop of the pressure of the flow-through amount of the cleaning fluid indicates a disturbance.

After dispensing the cleaning fluid successfully through the cleaning unit 26, it is conceivable that the loading space 3 is dried in order to complete the cleaning. Thus, it is conceivable to apply an air flow in particular to the loading space floor 39 or to the walls 38 and the loading space ceiling 40 using the cleaning nozzles 33 or separate air outlets, which dries out humidity caused by the dispensing of the cleaning fluid.

### REFERENCE NUMERALS AND DESIGNATIONS

1 Cleaning station
2 Transport device
3 Loading space
4 Support frame
5 Cleaning robot
6 Control unit
7 Pedestal
8 Garage
9 Fluid supply
10 Capture container
11 Stand element
12 Contact plane
13 Ground
14 Floor
15 Ceiling
16 Side wall
17 Interior space
18 Space divider element
19 Fluid tank
20 Fluid tank
21 Fluid tank
22 Pump
23 Liquid conduit
24 Frame
25 Chassis
26 Cleaning unit
27 Sensor device
28 Sensor
29 Distance sensor
30 Edge
31 Drive track
32 Main direction
33 Cleaning nozzle
34 Longitudinal axis of nozzle rail
35 Vertical axis
36 Nozzle rail
37 Electrical cabinet
36 Wall
39 Loading space floor
40 Loading space ceiling
41 Spray cone
42 Outer portion of pedestal
43 Intermediary space
44 Input direction
45 Display device
46 Sensor
47 Storage box
48 Signaling device
49 Capture device
50 Nozzle rail
51 Face wall
52 Winch
53 Cleaning device
54 Door support
55 Door
56 Processing device

What is claimed is:

1. A cleaning robot configured to clean a loading space of a transport device, the cleaning robot comprising:
a frame;
a chassis arranged at the frame;
a cleaning unit arranged at the frame; and
a sensor device,
wherein the chassis is formed by a track chassis including two drive tracks drivable independently from one another, wherein the drive tracks are arranged adjacent to one another and parallel to one another in a main direction of the cleaning robot,
wherein the cleaning unit includes a plurality of cleaning nozzles configured to dispense a cleaning fluid onto side walls defining a loading space of the transport device,
wherein the sensor device includes at least one distance sensor configured to capture information regarding distances of the cleaning robot from the side walls arranged opposite to one another and laterally defining the loading space of the transport device at a left side viewed in the main direction of the cleaning robot and at a right side viewed in the main direction of the cleaning robot and to transmit the information to a data processing device, and
wherein the data processing device is configured to process the information and control the chassis directly or indirectly as a function of the captured information, so that the drive tracks are temporarily driven differently, so that the cleaning robot is rotated about a vertical axis of the cleaning robot, and so that the main direction of the cleaning robot is aligned relative to the loading space.

2. The cleaning robot according to claim 1,
wherein the sensor device includes additional sensors configured as distance sensors configured to monitor an environment of the cleaning robot, and
wherein at least one distance sensor of the additional sensors is oriented forward in the main direction of the cleaning robot and/or at least one distance sensor of the additional sensors is oriented backward against the main direction of the cleaning robot.

3. The cleaning robot according to claim 1,
wherein the sensor device includes a pressure sensor or a flow through sensor capturing information regarding the cleaning fluid, and
wherein the information captured by the pressure sensor or the flow through sensor is transmittable to the data processing device and processable by the data processing device so that disturbances of a supply of the cleaning fluid are determinable.

4. The cleaning robot according to claim 1,
wherein the information captured by the at least one distance sensor is transmittable to the data processing device and processable by the data processing device, and
wherein the data processing device is configured to adjust at least one operating parameter of the cleaning robot as a function of the processed information, at least temporarily, indirectly, or directly.

5. The cleaning robot according to claim 4, wherein the at least one operating parameter of the cleaning robot is formed by
a dispensing direction of at least one of the cleaning nozzles;
a dispensing pressure of a cleaning fluid of at least at one of the cleaning nozzles;
a dispensing amount of the cleaning fluid of at least at one of the cleaning nozzles;
an activation condition of at least one of the cleaning nozzles;
a distance of at least one of the cleaning nozzles from one of the side walls of the loading space;
a temperature of the cleaning fluid;
a movement speed of the cleaning robot;
a concentration of a cleaning agent in the cleaning fluid; and
a distance of the cleaning robot from one of the side walls of the loading space.

6. The cleaning robot according to claim 1,
wherein at least one of the cleaning nozzles, or a plurality of the cleaning nozzles, or all of the cleaning nozzles, are movable by a motor indirectly or directly, so that a dispensing direction of the cleaning nozzles is adjustable during a cleaning process, wherein the cleaning fluid is dispensed by the cleaning nozzles substantially in the dispensing direction.

7. The cleaning robot according to claim 1,
wherein the cleaning unit includes a plurality of nozzle rails,
wherein a plurality of the cleaning nozzles is arranged at each of the nozzle rails,
wherein a nozzle rail of the nozzle rails is rotatable about a longitudinal axis of the nozzle rail adjusting a dispensing direction of the plurality of the cleaning nozzles arranged on the nozzle rail.

8. The cleaning robot according to claim 1, wherein the cleaning unit includes a plurality of valves configured to adjust a flow of the cleaning fluid through at least a portion of the cleaning nozzles.

9. The cleaning robot according to claim 1, further comprising: a control unit including the data processing device or connected in a data transferring manner with the data processing device and configured to receive information processed by the data processing device and to control the cleaning robot as a function of the information.

10. The cleaning robot according to one of the preceding claim 1, further comprising:
a transversally-oriented nozzle rail arranged at an upper end of the frame,
wherein the transversally-oriented nozzle rail is movable in a vertical direction relative to the frame at least during operation of the cleaning robot while maintaining an orientation of the transversally-oriented nozzle rail.
